(19) United States
(12) Patent Application Publication
(10) Pub. No.: US 2026/0081882 A1
(43) Pub. Date: Mar. 19, 2026

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Wenyuan CAI, Beijing (CN); Chengcheng WANG, Beijing (CN); Donglai LI, Beijing (CN); Tianbao LI, Beijing (CN); Ge LI, Beijing (CN); Shanshan DU, Beijing (CN)

(21) Appl. No.: 19/109,051

(22) PCT Filed: Feb. 18, 2024
(86) PCT No.: PCT/CN2024/077426

§ 371 Date: Mar. 5, 2025

(30) Foreign Application Priority Data
Feb. 28, 2023 (CN) 202310194622.1

(51) Int. Cl. H04L 51/02

(52) U.S. Cl. CPC H04L 51/02

(57) ABSTRACT

The present disclosure provides an information processing method and apparatus, an electronic device, and a storage medium. An information processing method includes: providing a first control in a target chat, wherein members of the target chat comprise a chat robot and a current user; creating a first human chat in response to a first operation on the first control, where members of the first human chat comprise the current user and a first human handler; and creating at least one further human chat through the target chat.

The present application claims priority to Chinese Patent Application No. 202310194622.1, filed with the China National Intellectual Property Administration on Feb. 28, 2023, and entitled “INFORMATION PROCESSING METHOD AND APPARATUS, ELECTRONIC DEVICE, AND STORAGE MEDIUM”, which is hereby incorporated by reference in its entirety.

### FIELD

The present disclosure relates to the field of computer technologies and, in particular, to an information processing method and apparatus, an electronic device, and a storage medium.

### BACKGROUND

With the development of technologies, a help desk function is provided in more and more clients. There are users and chat robots in the help desk. The users can obtain answers to related questions by asking the chat robots questions.

### SUMMARY

The present disclosure provides an information processing method and apparatus, an electronic device, and a storage medium.

The present disclosure adopts the following technical solutions.

In some embodiments, the present disclosure provides an information processing method. The method includes:
providing a first control in a target chat, where members of the target chat comprise a chat robot and a current user;
creating a first human chat in response to a first operation on the first control, where members of the first human chat comprise the current user and a first human handler; and
creating at least one further human chat through the target chat.

In some embodiments, the present disclosure provides an information processing apparatus. The apparatus includes:
a control unit configured to provide a first control in a target chat, where members of the target chat comprise a chat robot and a current user;
a creation unit configured to create a first human chat in response to a first operation on the first control, where members of the first human chat comprise the current user and a first human handler; and
the creation unit is further configured to create at least one further human chat through the target chat.

In some embodiments, the present disclosure provides an electronic device. The electronic device includes: at least one memory and at least one processor.

The memory is configured to store program codes, and the processor is configured to invoke the program codes stored in the memory to perform the above method.

In some embodiments, the present disclosure provides a computer-readable storage medium. The computer-readable storage medium is configured to store program codes, and the program codes, when run by a processor, cause the processor to perform the above method.

In the information processing method in some embodiments provided in the embodiments of the present disclosure, a first control is provided in a target chat, and a first human chat is created in response to a first operation on the first control. One human chat may be used to process one question. A user can create at least one further human chat through the target chat, so as to follow up and feedback on multiple questions at the same time, thereby solving a problem that one user can only feedback on and follow up one question but cannot feedback on and follow up multiple questions at the same time.

### BRIEF DESCRIPTION OF THE DRAWINGS

The above and other features, advantages, and aspects of the embodiments of the present disclosure become more apparent when taken in conjunction with the drawings and with reference to the following detailed description. Throughout the drawings, the same or similar reference numerals refer to the same or similar elements. It should be understood that the drawings are schematic and that elements and components are not necessarily drawn to scale.

FIG. 1 is a flowchart of an information processing method according to embodiments of the present disclosure.

FIG. 2 is a schematic diagram of a target chat according to embodiments of the present disclosure.

FIG. 3 is a schematic diagram of a work order according to embodiments of the present disclosure.

FIG. 4 to FIG. 7 are schematic diagrams of a target chat according to embodiments of the present disclosure.

FIG. 8 to FIG. 14 are schematic diagrams of a first human chat according to embodiments of the present disclosure.

FIG. 15 is a schematic structural diagram of an electronic device according to embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of the present disclosure.

It should be understood that various steps described in method implementations of the present disclosure may be performed sequentially and/or in parallel. Furthermore, the method implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “based, at least in part, on”. The term “an embodiment” means “at least one embodiment”; the term “another embodiment” means “at least one additional embodiment”; the term “some embodiments” means “at least some embodiments”. Related definitions of other terms will be given in the following description.

It should be noted that concepts such as “first” and “second” mentioned in the present disclosure are only used to distinguish between different apparatuses, modules, or units, and are not used to limit the order or interdependence of functions performed by these apparatuses, modules, or units.

It should be noted that the modification of “one” mentioned in the present disclosure is illustrative rather than restrictive, and those skilled in the art should understand that unless the context clearly indicates otherwise, it should be understood as “one or more”.

Names of messages or information exchanged between multiple apparatuses in implementations of the present disclosure are only used for illustrative purposes, and are not used to limit the scope of these messages or information.

The following describes in detail the solutions provided by the embodiments of the present disclosure with reference to the drawings.

A help desk is used inside or outside more and more enterprises. The help desk is a special chat, in which a chat robot is set up. A user sends a question in the help desk, and the chat robot answers the question. A work order, also known as a work document, is widely used in various enterprises. In a typical scenario, for example, teams such as customer service and sales need to answer questions from external customers when receiving the questions from the external customers. In the related art, when performing human service, a user can only feedback on one question at a time, and cannot feedback on or follow up multiple questions at the same time.

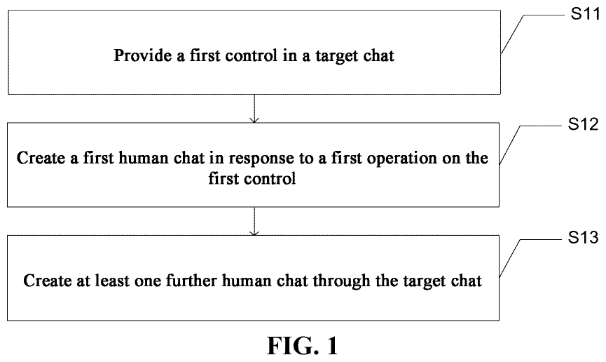

As shown in FIG. 1, FIG. 1 is a flowchart of an information processing method according to embodiments of the present disclosure. The method includes the following steps.
S11: a first control is provided in a target chat.

In some embodiments, the method provided in the present disclosure may be used for a client, for example, a communication client, or a functional platform integrating a communication function. For example, the functional platform may be a collaborative office platform, a shopping platform, a consulting platform, or the like. Members of the target chat include a chat robot and a current user. The target chat may be a help desk chat dedicated to the current user. There may be only the current user and the chat robot in the chat, or other users may enter the chat when the current user or the chat robot adds other users. The chat robot may be an automatic reply robot, which may be a robot customer service agent. The first control is provided in the target chat. The first control may be directly displayed in the target chat, or the first control may be displayed when a certain condition is met.
S12: a first human chat is created in response to a first operation on the first control.

In some embodiments, the first operation may be, for example, an operation of triggering the first control by means of clicking. After the current user performs the first operation, the first human chat is created. The first human chat is a human chat created this time. One human chat may be used to process one question or perform one human consulting. The first human chat may be used to process a first question, for example. Members of the first human chat include: the current user and a first human handler, and may also include the chat robot. A control for confirmation may be displayed before the first human chat is created, and the first human chat is created after the creation of the first human chat is confirmed through the control.
S13: at least one further human chat is created through the target chat.

In some embodiments, at least one further human chat may be created through the target chat before the processing of the first question ends. The further human chat may be a chat used to process another question.

In some embodiments, a human handler who is not a chat robot is added to the human chat to provide human service for the user. Therefore, the user can communicate with multiple human handlers at the same time to follow up and feedback on multiple questions. In some embodiments, one human chat may process one question. If the user has multiple questions to be processed, multiple human chats will be created. In this embodiment, the user does not need to wait for the first human chat to end. Before the processing of the first question is completed, other human chats may be created to process other questions. For example, the user may create a second human chat for processing a second question through the target chat after creating the first human chat and before the processing of the first question ends. In this way, the user can follow up and feedback on multiple questions at the same time, solving a problem that one user can only feedback on and follow up one question but cannot feedback on and follow up multiple questions at the same time. The target chat may be a dedicated group bound to the current user, and different users have their own dedicated groups respectively.

In some embodiments of the present disclosure, after the first human chat is created, the method further includes: obtaining a first work order corresponding to the first human chat, and updating the first work order based on a message in the first human chat.

In some embodiments, the first work order may be obtained by creating the first work order or obtaining an existing first work order. In the first human chat, the current user makes an inquiry related to the first question, and the first human handler also replies to the inquiry of the current user, that is, messages in the first human chat are generated. These messages are related to the first question, and the first work order may be a work order used to record a processing condition of the first question. Therefore, after the messages of the interaction between the current user and the first human handler are generated in the first human chat, the first work order needs to be updated according to these messages, for example, recording information such as the content of the first question, a processing status, and a human handler.

In some embodiments of the present disclosure, the providing a first control in a target chat includes: in response to the current user sending, in the target chat, a message related to a first question, replying by the chat robot based on the message related to the first question, and displaying the first control.

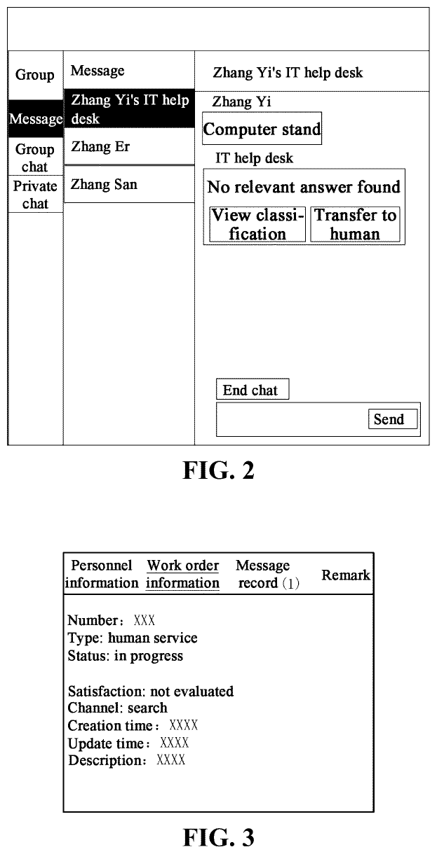

In some embodiments, before the first human chat is created, the user may directly perform the first operation on the first control to create the first human chat without sending messages in the target chat. In some other embodiments, the current user may send, in the target chat, the message related to the first question. The message related to the first question sent by the current user in the target chat may be a description or inquiry information of the current user on the first question, and a reply of the chat robot may be a reply to information about the first question proposed by the current user, for example, answering the question of the current user. Taking FIG. 2 as an example, if the user wants to ask a question about a computer stand and sends “computer stand” in the target chat, the robot will reply, for example, as shown in FIG. 2 if there is no relevant answer. At the same time, the first control will also be displayed, for example, the first control “transfer to human” is displayed in a message card of a reply message. After the user triggers the first control, the first human chat will be created.

In some embodiments of the present disclosure, the method further includes: after the message related to the first question is sent by the current user in the target chat, generating a second work order based on the message related to the first question; and after the first human chat is created, converting the second work order into the first work order, and updating the first work order based on a message in the first human chat.

In some embodiments, the current user may send an inquiry message of the first question in the target chat, and the second work order is generated based on these messages. The second work order may be a robot work order. Information such as a communication condition of the current user in the target chat and a processing condition of the first question is recorded through the second work order, so that background managers can gradually optimize a response control logic of the chat robot according to the condition fed back by the second work order. In some embodiments, taking FIG. 2 as an example, the current user sends “computer stand”, the second work order may be created by the chat robot, and the chat robot “IT help desk” replies “no relevant answer found” and provides the first control for transfer to human. The user triggers the first control by means of clicking or the like, the first human chat is created, and the second work order is converted into the first work order. FIG. 3 schematically shows the first work order. Then, as the current user communicates with the human handler in the first human reply, the first work order is updated according to the communicated messages.

In some embodiments, work orders are divided into robot work orders and human work orders. The work order created in the target chat is a robot work order, for example, the second work order. The work order created in the human chat is a human work order, for example, the first work order. After the second work order is converted into the first work order, the second work order no longer exists. Therefore, one question only corresponds to one work order. After the first work order is created, the messages related to the first question in the target chat and in the first human chat are also saved in one human work order. After the human work order is generated, the interaction in the target chat will generate a new robot work order.

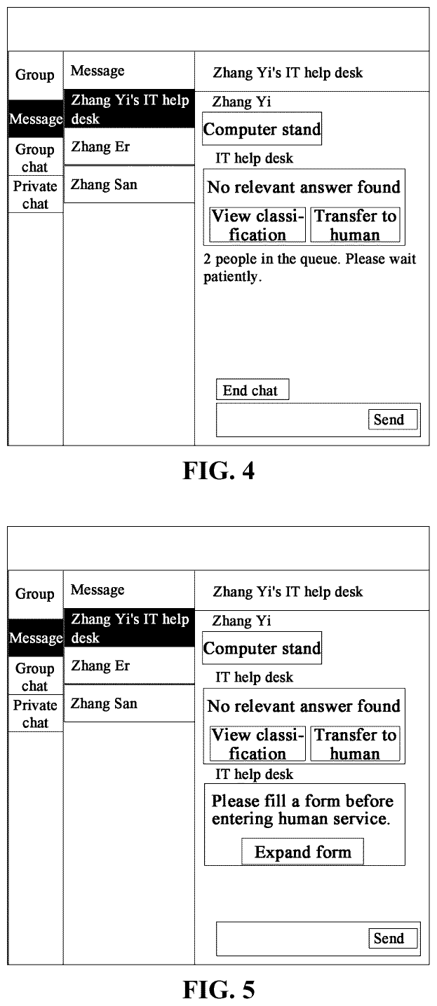

In some embodiments, after the first operation is performed on the first control, there may be no enough human handlers to be allocated, that is, queuing is required. At this time, as shown in FIG. 4, the number of people in the queue is displayed in the target chat. After the current user finishes queuing, the first human chat is created, and the first human chat can be automatically entered after the first human chat is created. In some embodiments, the number of people in the queue in the target chat may be updated in real time, or the number of people in the queue in the target chat may be updated when the first control is triggered. After the queuing ends, a prompt that the queuing ends is sent in the target chat to prompt that the human handler has been allocated.

In some embodiments of the present disclosure, creating the first human chat in response to the first operation on the first control includes: determining whether a form function is enabled in response to the first operation on the first control; in response to the form function being enabled, displaying a to-be-filled form in the target chat, creating the first human chat after the form is filled, and sending a first message generated based on the form to the first human chat; and in response to the form function being not enabled, creating the first human chat.

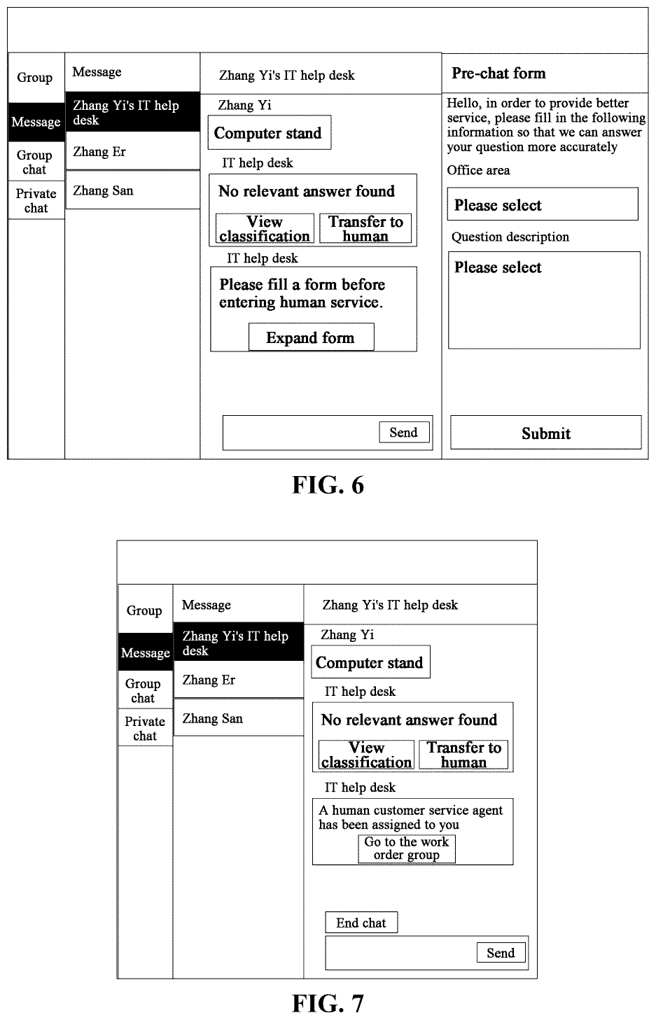

In some embodiments, before switching to the first human chat, the form may be filled in first. The form may be an associated form of the first question, which is used for the user to input information related to the first question. In this way, after the first human chat is created, the form is sent to the first human chat, thereby reducing the communication cost between the current user and the first human handler and reducing the communication time. In some embodiments, as shown in FIG. 5, after the first operation is performed on the first control, if the form function is enabled, a control “expand form” for opening the form may be displayed. After the control for opening the form is triggered, as shown in FIG. 6, the form is displayed, and a question description may be filled in the form. After the creation of the first human chat is completed, a message may be sent by the chat robot in the target chat, and a control for entering the first human chat is displayed in the message. As shown in FIG. 9, after entering the first human chat, the first message including the form is sent in the first human chat, so that the first human handler can know the first question according to the form.

In some embodiments of the present disclosure, after the first human chat is created, the method further includes: sending a second message in the first human chat, where the second message is generated based on the message related to the first question in the target chat.

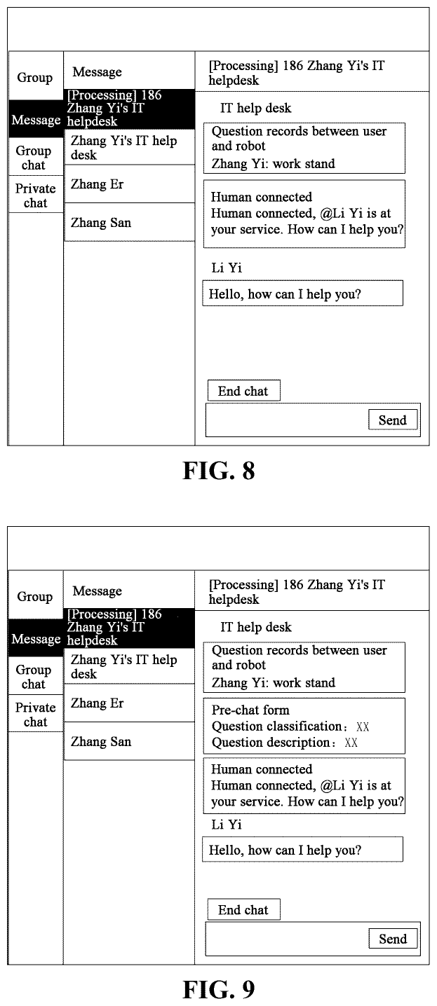

In some embodiments, “Processing 186 Zhang Yi's IT help desk” shown in FIG. 8 and FIG. 9 is the first human chat, and the second message (the first message in FIG. 8 and FIG. 9) is sent in the first human chat. The second message may be sent by the chat robot, and the second message may include the message sent by the current user in the target chat, so that the first human handler can quickly know the condition of the first question, avoiding the current user from repeatedly sending the message that has been sent in the target chat. In some embodiments, the second message may include the last N messages of the first question in the target chat, N may be 10, and a maximum number of text messages and a maximum number of picture messages in the N messages may be limited. The text messages may be preferentially displayed over the picture messages.

In some embodiments of the present disclosure, a name of the first human chat comprises: an information interaction state of the first human handler and/or the current user; and the name of the first human chat changes with a change in the information interaction state of the first human handler and/or the current user.

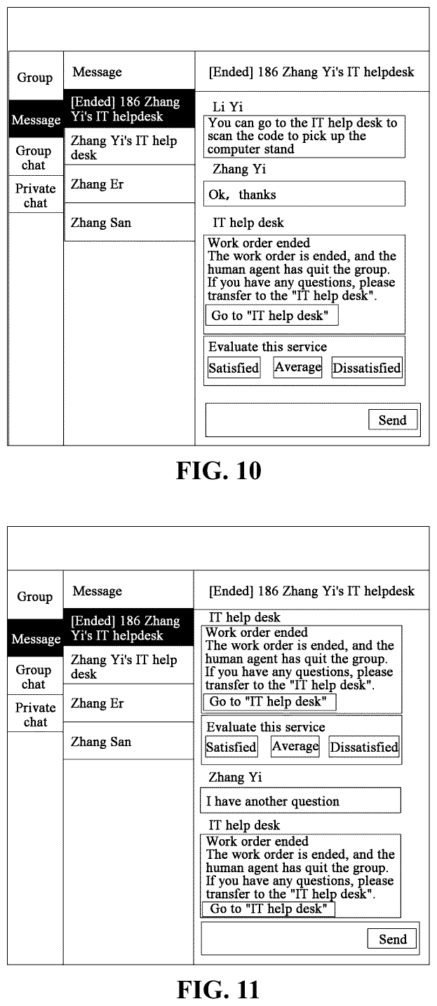

In some embodiments, the name of the first human chat is not fixed, and may automatically change according to one or both of an information interaction state of the human handler and an information interaction state of the current user. For example, as indicated in FIG. 8 and FIG. 9, the first human handler and the current user are interacting, and the first question is being processed. In FIG. 10, the interaction between the first human handler and the current user ends, and the processing of the first question ends, and the names of the first human chat are different. In this way, the processing state of the first human chat can be judged by the name of the first human chat.

In some embodiments of the present disclosure, a name of the first human chat comprises: at least part of a number of the first work order. In some embodiments, a name of the first human chat comprises: at least part of information filled in the form. In some embodiments, a name of the first human chat comprises: at least part of information in the message related to the first question.

In some embodiments, the name of the first human reply may be “processing state”+“work order number”+“description information of the first question” or “[user name] fixed field”, where the processing state is numbered in real time with a change in the processing state of the first question. The description information of the first question may be the last inquiry message about the first question sent by the current user in the target chat, or at least part of information filled in the form. The work order number may be the last N bits of the first work order. If there is no last inquiry message about the first question sent by the current user in the target chat and the form, “[user name] fixed field” is selected instead. For example, the name of the first human chat in FIG. 9 is [Processing] 186 Zhang Yi's IT help desk. In some embodiments, the user is not allowed to humanly modify the name of the human chat.

In some embodiments of the present disclosure, the method further includes: in response to a second operation of transferring the first work order from the first human handler to a second human handler, performing at least one of: creating a third work order, retaining or removing the first human handler in the first human chat based on a transfer setting, or adding the second human handler to the first human chat.

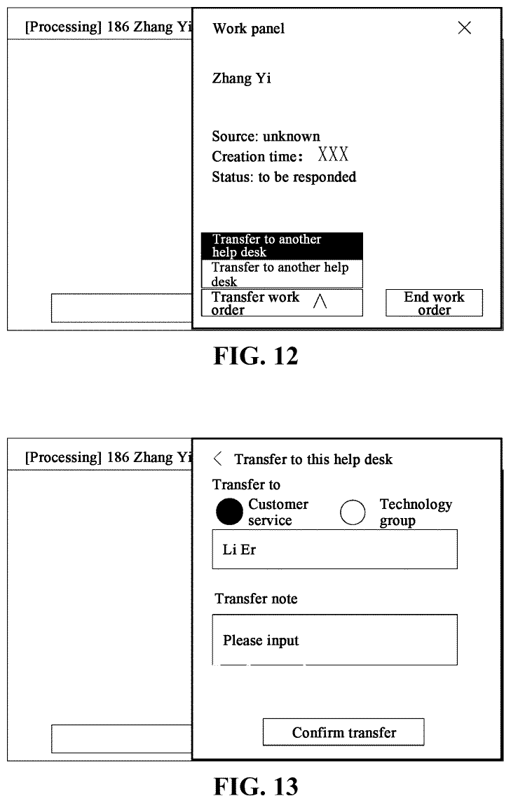

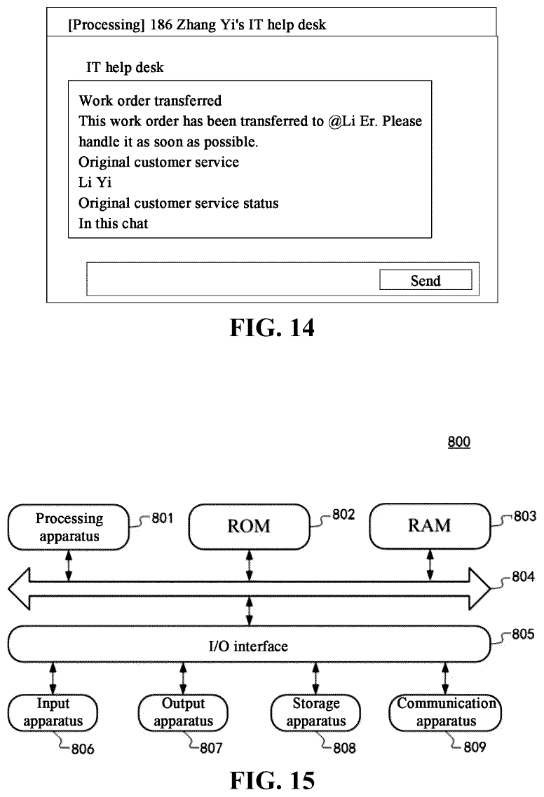

In some embodiments, if the current user or a manager is not satisfied with the first human handler and wants to change the human handler, the first work order may be transferred to another human handler. As shown in FIG. 12, a transfer work panel may be displayed after a transfer control in the first human reply is triggered. In the work panel, another human handler may be selected to transfer the first work order to, and an organization (this help desk or another help desk) to which the transferred second human handler belongs may be selected. As shown in FIG. 13, after the organization to which the second human handler belongs is selected, a restriction condition of the second human handler and the selected second human handler are further displayed. A transfer note may be input during transfer, and the transfer note will be sent to the second human handler. After the transfer of the first work order to the second human handler is performed, as shown in FIG. 14, a notification message may be sent by the chat robot, and the second human handler may be automatically added to the first human reply. During transfer, whether the first human handler is removed from the first human chat may be set.

In some embodiments of the present disclosure, the method further includes: in response to a second operation on a second control in the first human chat, performing at least one of: sending an evaluation control in the first human chat, retaining the first human chat, sending a third message indicating that an interaction with the first human handler has ended in the first human chat, displaying a control for jumping back to the target chat, removing a human handler in the first human chat from the first human chat, or displaying a control for jumping back to the target chat in response to information being sent in the first human chat by the current user.

In some embodiments, as shown in FIG. 8 and FIG. 9, there is a second control “end consulting” at the bottom of the first human chat. The second control may be triggered by means of clicking or the like, so that the interaction with the first human handler may end. At this time, as shown in FIG. 10, an evaluation control may be sent by the chat robot in the first human chat, and the current user may evaluate the processing condition. Whether to send the evaluation control is settable. Moreover, the first human chat will not be dissolved, that is, the first human chat is not a temporary chat, and the user can find the chat in a feed list. The chat robot may also send a third message to inform that the interaction with the first human handler has ended. A control for jumping back to the target chat may be displayed in the third message, and the human handler (such as the first human handler) is removed from the first human chat, leaving only the chat robot and the current user in the first human chat. If the current user continues to send information in the first human chat, as shown in FIG. 11, Zhang Yi sends “I have another question”. Since one chat only processes one question and the human handler has exited, the control for jumping back to the target chat will be displayed. For example, the third message may be resent at this time. In this way, it is avoided that one human chat processes multiple questions.

In some embodiments of the present disclosure, the human chat may be created by the chat robot, and members in the human chat may include the chat robot, and the chat robot may create the first work order or the second work order. After the first human chat is created, a third control for entering the first human chat is displayed in the target chat. Reference may be made to FIG. 7, where a button “go to work order group” is the third control.

In some embodiments of the present disclosure, in the first human chat, in response to the first human handler not replying to the current user within a first preset time period, a fourth message being sent to an administrator, the fourth message being used to jump to the first human chat after a third operation is performed, and/or the fourth message being used to remind the first human handler after a fourth operation is performed. In some embodiments, if the first human handler does not reply to the user for a long time in the first human reply, the user experience will be low. At this time, the fourth message will be sent to the administrator, and the fourth message may include a control for jumping to the first human chat, so that the administrator can enter the first human reply to chat with the user about the question. The fourth message may also include a control for reminding the first human handler, and a reminder message is sent to the first human handler by triggering the control.

In some embodiments of the present disclosure, after the second work order is generated based on the message related to the first question, in response to no interaction existing in the target chat for a second preset time period, the second work order is closed. In some embodiments, after the second work order is generated, if the first work order is not generated, the second work order will be retained without being converted into the first work order. At this time, the second work order will be updated according to messages in the target chat. If the second work order is not updated for a long time, it indicates that the user has probably solved the problem, and there is no need to continue to update the second work order. Therefore, the second work order is closed.

In some embodiments of the present disclosure, after the first human chat is created, in response to a message related to a second question being sent in the target chat, a fourth work order is generated based on the message related to the second question. In some embodiments, one question may correspond to one work order. The first question corresponds to the second work order, and the second work order is converted into the first work order after the first human chat is created. At this time, the work order corresponding to the first question becomes the first work order. If the message related to the second question continues to be sent in the target chat, a fourth work order corresponding to the second question will be generated. If the first control is triggered at this time, another human chat will be generated, and the fourth work order is converted into a fifth work order. The work order generated by the target chat may be a robot work order, and the work order in the human chat may be a human work order.

In some embodiments of the present disclosure, a first setup control may be provided. If the first setup control is in a first state, after the first operation is performed on the first control, the first human chat is created, and the current user and the first human handler are invited to enter the chat. At this time, one user can create multiple human chats, and thus multiple work orders can be created. One work order corresponds to one human chat. The current user can continue to process a second question before the processing of the first question ends. The chat robot can create a form of the second question, so that the current user can follow up and process multiple questions at the same time, and there may be multiple work orders that are not closed at the same time. If the first setup control is in a second state, the next question can only be processed after the processing of the first question ends, and another human chat can be created after the processing of the first question ends. Only one work order is in an open state at a time.

In some embodiments, the target chat is a dedicated chat, each user corresponds to one target chat, and members are only the user and the chat robot. In some other embodiments, the target chat may be any chat, and the chat only needs to have the chat robot added thereto. That is, the present disclosure can be used for different usage scenarios, and it can be limited to perform the operations in the dedicated chat or the general chat to create the human chat. In some embodiments, whether the target chat is a dedicated chat or any chat is settable, and may be set up through a second setup control. In some embodiments, the second setup control may be displayed when the user has a preset permission. At this time, the target chat may be defaulted to the dedicated chat, otherwise it will not be displayed. The target chat and the human chat may be distinguished by attribute information of the chat.

In some embodiments, when the target chat is a first-type chat, the first setup control may not be displayed. At this time, it may be defaulted that the first setup control is in the first state. When the target chat is a second-type chat, the first setup control is displayed, and the user can select the state of the first setup control independently.

In some embodiments of the present disclosure, a work order is created in the form of a chat, different chats are created for different questions, a question description is used as a chat name, and a processing state (a processing state of a question) of work order processing is synchronized at the chat name, so that different questions and different processing states can be conveniently distinguished.

The present disclosure further provides an information processing apparatus. The apparatus includes:
a control unit configured to provide a first control in a target chat, where members of the target chat comprise a chat robot and a current user;
a creation unit configured to create a first human chat in response to a first operation on the first control, where members of the first human chat comprise the current user and a first human handler; and
the creation unit is further configured to create at least one further human chat through the target chat.

In some embodiments, the control unit is further configured to: after the first human chat is created, obtain a first work order corresponding to the first human chat, and update the first work order based on a message in the first human chat.

In some embodiments, the providing a first control in a target chat includes: in response to the current user sending, in the target chat, a message related to a first question, replying by the chat robot based on the message related to the first question, and displaying the first control.

In some embodiments, the control unit is further configured to: after the message related to the first question is sent by the current user in the target chat, generate a second work order based on the message related to the first question; and
after the first human chat is created, convert the second work order into the first work order, and update the first work order based on a message in the first human chat.

In some embodiments, creating the first human chat in response to the first operation on the first control includes: determining whether a form function is enabled in response to the first operation on the first control;
in response to the form function being enabled, displaying a to-be-filled form in the target chat, creating the first human chat after the form is filled, and sending a first message generated based on the form to the first human chat; and
in response to the form function being not enabled, creating the first human chat.

In some embodiments, the control unit is further configured to: after the first human chat is created, send a second message in the first human chat, where the second message is generated based on the message related to the first question in the target chat.

In some embodiments, a name of the first human chat comprises: an information interaction state of the first human handler and/or the current user; and
the name of the first human chat changes with a change in the information interaction state of the first human handler and/or the current user.

In some embodiments, a name of the first human chat comprises: at least part of a number of the first work order.

In some embodiments, a name of the first human chat comprises: at least part of information filled in the form.

In some embodiments, a name of the first human chat comprises: at least part of information in the message related to the first question.

In some embodiments, the control unit is further configured to: in response to a second operation of transferring the first work order from the first human handler to a second human handler, perform at least one of:
creating a third work order, retaining or removing the first human handler in the first human chat based on a transfer setting, or adding the second human handler to the first human chat.

In some embodiments, the control unit is further configured to: in response to a second operation on a second control in the first human chat, perform at least one of:
sending an evaluation control in the first human chat, retaining the first human chat, sending a third message indicating that an interaction with the first human handler has ended in the first human chat, displaying a control for jumping back to the target chat, removing a human handler in the first human chat from the first human chat, or displaying a control for jumping back to the target chat in response to information being sent in the first human chat by the current user.

In some embodiments, the human chat is created by the chat robot.

In some embodiments, members in the human chat include the chat robot.

In some embodiments, the control unit is further configured to: after the first human chat is created, display a third control for entering the first human chat in the target chat.

In some embodiments, the control unit is further configured to: in the first human chat, in response to the first human handler not replying to the current user within a first preset time period, sent a fourth message to an administrator, the fourth message being used to jump to the first human chat after a third operation is performed, and/or the fourth message being used to remind the first human handler after a fourth operation is performed.

In some embodiments, during the at least one further human chat being created through the target chat, an interaction with the first human handler in the first human chat has not ended.

In some embodiments, the control unit is further configured to: after the second work order is generated based on the message related to the first question and in response to no interaction existing in the target chat for a second preset time period, close the second work order.

In some embodiments, the control unit is further configured to: after the first human chat is created and in response to a message related to a second question being sent in the target chat, generate a fourth work order based on the message related to the second question.

The apparatus embodiments correspond to the method embodiments basically, and thus reference may be made to the descriptions of the method embodiments for related parts. The apparatus embodiments described above are merely illustrative, and the modules described as separate modules may be or may not be separate. Some or all of the modules may be selected according to actual needs to achieve the purpose of the solutions in the embodiments. Those of ordinary skill in the art can understand and implement the solutions without creative effort.

The methods and apparatuses of the present disclosure are described above based on the embodiments and application examples. In addition, the present disclosure further provides an electronic device and a computer-readable storage medium, which are described below.

Reference is made to FIG. 15 below, which illustrates a schematic structural diagram of an electronic device 800 (such as a terminal device or a server) suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable multimedia player (PMP), a vehicle-mounted terminal (such as a vehicle-mounted navigation terminal), and a fixed terminal such as a digital TV and a desktop computer. The electronic device shown in the figure is only an example, and should not impose any limitation to the function and usage scope of the embodiments of the present disclosure.

The electronic device 800 may include a processing apparatus (such as a central processing unit and a graphics processing unit) 801. The processing apparatus 801 may perform various appropriate actions and processing according to a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, a gyroscope, and the like; an output apparatus 807 including, for example, a liquid crystal display (LCD), a speaker, a vibrator, and the like; the storage apparatus 808 including, for example, a magnetic tape, a hard disk, and the like; and a communication apparatus 809. The communication apparatus 809 may allow the electronic device 800 to perform wireless or wired communication with other devices to exchange data. Although the figure shows the electronic device 800 having various apparatuses, it should be understood that not all of the illustrated apparatuses are necessarily implemented or provided. Alternatively, more or fewer apparatuses may be implemented or provided.

In particular, according to the embodiments of the present disclosure, the process described above with reference to the flowchart may be implemented as a computer software program. For example, embodiments of the present disclosure include a computer program product, which includes a computer program carried on a computer-readable medium, and the computer program includes program codes for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program. The program may be used by or in conjunction with an instruction execution system, apparatus, or device. In the present disclosure, the computer-readable signal medium may include a data signal that propagates in a baseband or as part of a carrier and carries computer-readable program codes. The data signal propagating in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes contained in the computer-readable medium may be transmitted by any suitable medium, including, but not limited to, a wire, an optical cable, radio frequency (RF), or any suitable combination thereof.

In some implementations, the client and the server may communicate using any currently known or future-developed network protocol such as Hypertext transfer protocol (HTTP), and may be interconnected with any form or medium of digital data communication (for example, a communication network). Examples of the communication network include a local area network (“LAN”), a wide area network (“WAN”), an internet, and a peer-to-peer network (for example, an ad hoc network), and any currently known or future-developed network.

The above computer-readable medium may be included in the above electronic device, or may exist alone without being assembled into the electronic device.

The above computer-readable medium carries one or more programs, which, when executed by the electronic device, cause the electronic device to execute the above method of the present disclosure.

The computer program codes for performing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program codes may be executed entirely on a user computer, partly on a user computer, as a stand-alone software package, partly on a user computer and partly on a remote computer, or entirely on a remote computer or server. In the case of a remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, program segment, or part of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by special purpose hardware-based systems that perform the specified functions or operations, or combinations of special purpose hardware and computer instructions.

The units involved in the embodiments described in the present disclosure may be implemented in software or hardware. The name of a unit does not constitute a limitation of the unit itself under certain circumstances.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, an information processing method is provided. The method includes:
providing a first control in a target chat, where members of the target chat comprise a chat robot and a current user;
creating a first human chat in response to a first operation on the first control, where members of the first human chat comprise the current user and a first human handler; and
creating at least one further human chat through the target chat.

According to one or more embodiments of the present disclosure, an information processing method is provided. After the first human chat is created, the method further includes: obtaining a first work order corresponding to the first human chat, and updating the first work order based on a message in the first human chat.

According to one or more embodiments of the present disclosure, an information processing method is provided. The providing a first control in a target chat includes: in response to the current user sending, in the target chat, a message related to a first question, replying by the chat robot based on the message related to the first question, and displaying the first control.

According to one or more embodiments of the present disclosure, an information processing method is provided. The method further includes: after the message related to the first question is sent by the current user in the target chat, generating a second work order based on the message related to the first question; and
after the first human chat is created, converting the second work order into the first work order, and updating the first work order based on a message in the first human chat.

According to one or more embodiments of the present disclosure, an information processing method is provided. The creating a first human chat in response to a first operation on a first control includes:
determining whether a form function is enabled in response to the first operation on the first control;
in response to the form function being enabled, displaying a to-be-filled form in the target chat, creating the first human chat after the form is filled, and sending a first message generated based on the form to the first human chat; and
in response to the form function being not enabled, creating the first human chat.

According to one or more embodiments of the present disclosure, an information processing method is provided. After the first human chat is created, the method further includes: sending a second message in the first human chat, where the second message is generated based on the message related to the first question in the target chat.

According to one or more embodiments of the present disclosure, an information processing method is provided. A name of the first human chat comprises: an information interaction state of the first human handler and/or the current user; and
the name of the first human chat changes with a change in the information interaction state of the first human handler and/or the current user.

According to one or more embodiments of the present disclosure, an information processing method is provided. A name of the first human chat comprises: at least part of a number of the first work order.

According to one or more embodiments of the present disclosure, an information processing method is provided. A name of the first human chat comprises: at least part of information filled in the form.

According to one or more embodiments of the present disclosure, an information processing method is provided. A name of the first human chat comprises: at least part of information in the message related to the first question.

According to one or more embodiments of the present disclosure, an information processing method is provided. The method further includes:
in response to a second operation of transferring the first work order from the first human handler to a second human handler, performing at least one of:
creating a third work order, retaining or removing the first human handler in the first human chat based on a transfer setting, or adding the second human handler to the first human chat.

According to one or more embodiments of the present disclosure, an information processing method is provided. The method further includes:
in response to a second operation on a second control in the first human chat, performing at least one of:
sending an evaluation control in the first human chat, retaining the first human chat, sending a third message indicating that an interaction with the first human handler has ended in the first human chat, displaying a control for jumping back to the target chat, removing a human handler in the first human chat from the first human chat, or displaying a control for jumping back to the target chat in response to information being sent in the first human chat by the current user.

According to one or more embodiments of the present disclosure, an information processing method is provided. At least one of the following is satisfied:
the human chat being created by the chat robot;
members in the human chat comprising the chat robot;
after the first human chat is created, a third control for entering the first human chat being displayed in the target chat;
in the first human chat, in response to the first human handler not replying to the current user within a first preset time period, a fourth message being sent to an administrator, the fourth message being used to jump to the first human chat after a third operation is performed, and/or the fourth message being used to remind the first human handler after a fourth operation is performed; or
during the at least one further human chat being created through the target chat, an interaction with the first human handler in the first human chat having not ended.

According to one or more embodiments of the present disclosure, an information processing method is provided. At least one of the following is satisfied:
after the second work order is generated based on the message related to the first question, in response to no interaction existing in the target chat for a second preset time period, closing the second work order; and
after the first human chat is created, in response to a message related to a second question being sent in the target chat, generating a fourth work order based on the message related to the second question.

According to one or more embodiments of the present disclosure, an information processing apparatus is provided. The apparatus includes:
a control unit configured to provide a first control in a target chat, where members of the target chat comprise a chat robot and a current user;
a creation unit configured to create a first human chat in response to a first operation on the first control, where members of the first human chat comprise the current user and a first human handler; and
the creation unit is further configured to create at least one further human chat through the target chat.

According to one or more embodiments of the present disclosure, an electronic device is provided. The electronic device includes: at least one memory and at least one processor.

The memory is configured to store program codes, and the processor is configured to invoke the program codes stored in the memory to perform the above method.

According to one or more embodiments of the present disclosure, a computer-readable storage medium is provided. The computer-readable storage medium is configured to store program codes, and the program codes, when run by a processor, cause the processor to perform the above method.

The above description is merely illustrative of the preferred embodiments of the present disclosure and the technical principles employed. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the technical solutions formed by replacing the above features with technical features with similar functions disclosed in the present disclosure (but not limited to).

Furthermore, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely exemplary forms for implementing the claims.

1. An information processing method, comprising:
providing a first control in a target chat, wherein members of the target chat comprise a chat robot and a current user;
creating a first human chat in response to a first operation on the first control, wherein members of the first human chat comprise the current user and a first human handler; and
creating at least one further human chat through the target chat.

2. The method according to claim 1, wherein after the first human chat is created, the method further comprises: obtaining a first work order corresponding to the first human chat, and updating the first work order based on a message in the first human chat.

3. The method according to claim 1, wherein providing the first control in the target chat comprises:
in response to the current user sending, in the target chat, a message related to a first question, replying by the chat robot based on the message related to the first question, and displaying the first control.

4. The method according to claim 3, further comprising:
after the message related to the first question is sent by the current user in the target chat, generating a second work order based on the message related to the first question; and
after the first human chat is created, converting the second work order into the first work order, and updating the first work order based on the message in the first human chat.

5. The method according to claim 1, wherein creating the first human chat in response to the first operation on the first control comprises:
determining whether a form function is enabled in response to the first operation on the first control;
in response to the form function being enabled, displaying a to-be-filled form in the target chat, creating the first human chat after the form is filled, and sending a first message generated based on the form to the first human chat; and
in response to the form function being not enabled, creating the first human chat.

6. The method according to claim 3, wherein after the first human chat is created, the method further comprises: sending a second message in the first human chat, wherein the second message is generated based on the message related to the first question in the target chat.

7. The method according to claim 1, wherein
a name of the first human chat comprises: an information interaction state of the first human handler and/or the current user; and
the name of the first human chat changes with a change in the information interaction state of the first human handler and/or the current user.

8. The method according to claim 2, wherein
a name of the first human chat comprises: at least part of a number of the first work order.

9. The method according to claim 5, wherein
a name of the first human chat comprises: at least part of information filled in the form.

10. The method according to claim 3, wherein
a name of the first human chat comprises: at least part of information in the message related to the first question.

11. The method according to claim 2, further comprising:
in response to a second operation of transferring the first work order from the first human handler to a second human handler, performing at least one of:
creating a third work order, retaining or removing the first human handler in the first human chat based on a transfer setting, or adding the second human handler to the first human chat.

12. The method according to claim 1, further comprising:
in response to a second operation on a second control in the first human chat, performing at least one of:
sending an evaluation control in the first human chat, retaining the first human chat, sending a third message indicating that an interaction with the first human handler has ended in the first human chat, displaying a control for jumping back to the target chat, removing a human handler in the first human chat from the first human chat, or displaying [[a]] the control for jumping back to the target chat in response to information being sent in the first human chat by the current user.

13. The method according to claim 1, wherein at least one of followings is satisfied:
the human chat being created by the chat robot;
members in the human chat comprising the chat robot;
after the first human chat is created, a third control for entering the first human chat being displayed in the target chat;
in the first human chat, in response to the first human handler not replying to the current user within a first preset time period, a fourth message being sent to an administrator, the fourth message being used to jump to the first human chat after a third operation is performed, and/or the fourth message being used to remind the first human handler after a fourth operation is performed; or
during the at least one further human chat being created through the target chat, an interaction with the first human handler in the first human chat having not ended.

14. The method according to claim 4, wherein at least one of followings is satisfied:
after the second work order is generated based on the message related to the first question, in response to no interaction existing in the target chat for a second preset time period, closing the second work order; and
after the first human chat is created, in response to a message related to a second question being sent in the target chat, generating a fourth work order based on the message related to the second question.

15. (canceled)

16. An electronic device, comprising:
at least one memory and at least one processor,
wherein the at least one memory is configured to store program codes, and the program codes, when executed by the at least one processor, cause the electronic device to:
provide a first control in a target chat, wherein members of the target chat comprise a chat robot and a current user;
create a first human chat in response to a first operation on the first control, wherein members of the first human chat comprise the current user and a first human handler; and
create at least one further human chat through the target chat.

17. A non-transitory computer-readable storage medium, configured to store program codes, wherein the program codes, when run by a processor, cause the processor to:
provide a first control in a target chat, wherein members of the target chat comprise a chat robot and a current user;
create a first human chat in response to a first operation on the first control, wherein members of the first human chat comprise the current user and a first human handler; and
create at least one further human chat through the target chat.

18. The electronic device according to claim 16, wherein the program codes further cause the electronic device to: after the first human chat is created, obtain a first work order corresponding to the first human chat, and update the first work order based on a message in the first human chat.

19. The electronic device according to claim 16, wherein the program codes causing the electronic device to provide the first control in the target chat further cause the electronic device to:
in response to the current user sending, in the target chat, a message related to a first question, reply by the chat robot based on the message related to the first question, and display the first control.

20. The electronic device according to claim 19, the program codes further cause the electronic device to:
after the message related to the first question is sent by the current user in the target chat, generate a second work order based on the message related to the first question; and
after the first human chat is created, convert the second work order into the first work order, and update the first work order based on the message in the first human chat.

21. The electronic device according to claim 16, wherein the program codes causing the electronic device to create the first human chat in response to the first operation on the first control further cause the electronic device to:
determine whether a form function is enabled in response to the first operation on the first control;
in response to the form function being enabled, displaying a to-be-filled form in the target chat, create the first human chat after the form is filled, and send a first message generated based on the form to the first human chat; and
in response to the form function being not enabled, create the first human chat.
